(19) United States
(12) Patent Application Publication
(10) Pub. No.: US 2014/0010417 A1
(43) Pub. Date: Jan. 9, 2014

(54) COMMAND INPUT METHOD OF TERMINAL AND TERMINAL FOR INPUTTING COMMAND USING MOUTH GESTURE

(71) Applicant: Korea Advanced Institute of Science and Technology, Daejeon (KR)

(72) Inventor: Sungjae HWANG, Daejeon (KR)

(21) Appl. No.: 13/928,931

(22) Filed: Jun. 27, 2013

(30) Foreign Application Priority Data
Jul. 4, 2012 (KR) 10-2012-0072893

(51) Int. Cl. G06K 9/00

(52) U.S. Cl. CPC G06K 9/00288
USPC 382/118

(57) ABSTRACT

A command input method of a terminal includes: acquiring an image including a user's face region through a camera; detecting a mouth region from the user's face region; inputting a command to the terminal or to an application being executed in the terminal if a mouth gesture of the mouth region is identical to an unlock gesture stored in the terminal. The user may make the same mouth gesture as a pre-set unlock gesture, or make a mouth gesture corresponding to an authentication message displayed on a display panel of the terminal. The command may be an unlock command for unlocking the terminal or the application or a command for executing a predetermined function while unlocking the terminal or the application.

### CROSS-REFERENCE TO RELATED APPLICATION

This application claims priority to and the benefit under 35 U.S.C. §119(a) of Korean Patent Application No. 2012-0072893, filed on Jul. 4, 2012, in the Korean Intellectual Property Office, the entire disclosure of which is incorporated herein by reference for all purpose.

### BACKGROUND

1. Field

The following description relates to a command input method using a user's mouth gesture as a command for a terminal, and the terminal using the command input method.

2. Description of Related Art

With popularization of terminals such as a smartphone, the security of terminals is becoming an important issue. The reason is because a terminal such as a smartphone may store personal information, such as phone numbers, pictures, and the like, and may execute a personal social network service (SNS) application, an application including money and banking information, etc.

For security of terminals, many terminals support a personal identification number (PIN)-based unlock method or a drag pattern-based unlock method. Lately, terminals supporting a face recognition-based unlock method have been developed.

The drag pattern-based unlock method has an advantage that a user can easily unlock a mobile terminal through a simple operation. However, the drag pattern-based unlock method may be easily exposed to shoulder surfing and a smudge attack of discerning a password pattern from a drag trace on a touch screen.

### SUMMARY

In one general aspect, there is provided a command input method of a terminal with a camera, including: acquiring an image including a user's face region through the camera; detecting a mouth region from the user's face region; inputting a command to the terminal or to an application being executed in the terminal if a mouth gesture of the mouth region is identical to an unlock gesture stored in the terminal.

The command input method, may further including: detecting the user's face region from the image; and determining whether the user's face region is identical to an authorized user's face image stored in the terminal, wherein the detecting of the mouth region from the user's face region comprises detecting the mouth region if the user's face region is identical to the authorized user's face image.

The mouth gesture is at least one gesture among a gesture of pronouncing at least one vowel, a gesture of pronouncing at least one consonant, a gesture of pronouncing a specific syllable, a gesture of pronouncing a specific word, and a gesture of pronouncing a specific sentence.

The unlock gesture is the user's mouth gesture acquired through the camera and stored in the terminal by the user, or a standard gesture matching at least one of a specific vowel, a specific consonant, a specific syllable, a specific word, and a specific sentence.

The command includes at least one command among an unlock command, a command for executing a specific application, a command for terminating a specific application, a command for dialing a specific phone number, and a command for sending a message to a person with a specific phone number.

In another aspect, there is provided a command input method of a terminal with a camera, including: displaying an authentication message on a display panel of the terminal; acquiring a first image including a user's face region through the camera; detecting a first mouth region of the user from the user's face region; and inputting a command to the terminal or to an application being executed in the terminal if a first mouth gesture of the first mouth region is identical to an unlock gesture corresponding to the authentication message.

The command input method may further including: before displaying the authentication message, detecting the user's face region from the first image acquired through the camera; and determining whether the user's face region is identical to an authorized user's face image stored in the terminal, wherein the displaying of the authentication message comprises displaying the authentication message only if the user's face region is identical to the authorized user's face image.

The command input method may further including: after acquiring the first image, determining whether the user's face region is identical to the authorized user's face image stored in the terminal, wherein the detecting of the first mouth region is performed only if the user's face region is identical to the authorized user's face image.

The command input method may further including: after inputting the command to the terminal or to the application, acquiring a second image through the camera, and detecting a second mouth region of the user from the second image; and executing a command corresponding to a mouth gesture of the second mouth region.

The command is a command matching the authentication message or at least one syllable constituting the authentication message and stored in advance in the terminal.

In yet another general aspect, there is provided a terminal of inputting a command using a mouth gesture, the terminal including: a camera acquiring an image including a user's face region; a mouth detection module detecting a mouth region from the image using an image processing technique; a memory storing an unlock gesture; and a control module comparing a mouth gesture of the mouth region to the unlock gesture, and inputting a command to the terminal or to an application being executed in the terminal.

The memory further stores an authorized user's face image, and the control module detects the user's face region from the image, and compares the mouth region to the unlock gesture if the user's face region is identical to the authorized user's face image.

The mouth detection module detects the user's face region using a histogram distribution of the image, and detects the mouth region from a grayscale image about the user's face region by thresholding brightness values.

The mouth detection module recognizes the mouth gesture from the mouth region, using at least one among an aspect ratio of lips, a size of the lips, a size of an imaginary quadrangle surrounding the lips, a size of an imaginary circle surrounding the lips, and outlines of the lips.

The unlock gesture is a user's mouth gesture acquired through the camera and stored in the terminal by the user, or a standard gesture matching at least one of a specific vowel, a specific consonant, a specific syllable, a specific word, and a specific sentence.

The terminal may further includes a display panel outputting an authentication message stored in the memory, wherein the unlock gesture is a mouth gesture corresponding to the authentication message.

### BRIEF DESCRIPTION OF THE DRAWINGS

FIG. 1 illustrates an example in which a user inputs a mouth gesture through a camera of a terminal.

FIG. 2 illustrates examples of mouth gestures corresponding to vowels.

FIG. 3 is a flowchart illustrating an example of a process of detecting a mouth gesture from an image including a user's face, according to an embodiment of the present invention.

FIG. 4 is a flowchart illustrating an example of a command input method of a terminal.

FIG. 5 is a flowchart illustrating an example of a command input method of a terminal.

FIG. 6 is a block diagram illustrating an example of a configuration of a terminal inputting a command using a mouth gesture.

FIG. 7 is a block diagram illustrating an example of a configuration of a terminal inputting a command using a mouth gesture.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. Also, descriptions of well-known functions and constructions may be omitted for increased clarity and conciseness.

The presently described examples will be understood by reference to the drawings, wherein like parts are designated by like numerals throughout. The drawings are not necessarily drawn to scale, and the size and relative sizes of the layers and regions may have been exaggerated for clarity.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

Before starting detailed explanations of figures, components that will be described in the specification are discriminated merely according to functions mainly performed by the components or conventionally carried out according to common knowledge of related technical fields. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

As described above, for security of terminals, many terminals support a personal identification number (PIN)-based unlock method or a drag pattern-based unlock method. However, the PIN-based unlock method may cause inconvenience to users, and the drag pattern-based unlock method is vulnerable to a smudge attack and the like. Lately, terminals supporting a face recognition-based unlock method have been developed. However, the face recognition-based unlock method also has a problem that another person can easily unlock a terminal with a user's picture.

According to an embodiment of the present invention, a method of acquiring a user's image using a camera installed in a terminal, detecting a mouth gesture from the user's image, and unlocking the terminal based on the mouth gesture is proposed.

In this disclosure, a terminal includes devices with a camera, e.g., a general mobile phone, a smartphone, a tablet PC, a notebook, etc., and includes all devices having a lock function for preventing an unauthorized use.

In this disclosure, a mouth gesture means a user's mouth (lips) shape. The mouth gesture includes a user's mouth shape made when the user pronounces a specific vowel, consonant, syllable, word, or sentence. Accordingly, the mouth gesture may be a mouth shape or a series of mouth shapes.

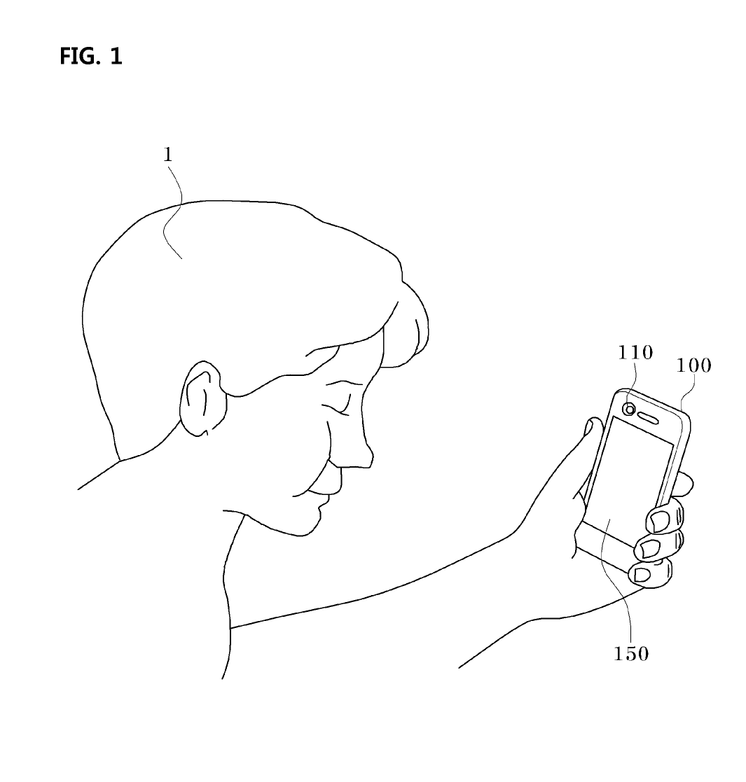

FIG. 1 illustrates an example in which a user 1 inputs a mouth gesture through a camera 110 of a terminal 100. In the example of FIG. 1, the terminal 100 is a mobile terminal such as a smartphone. In case of the terminal 100 such as a smartphone, the camera 110 may be disposed in the front side of the terminal 100 on which a display panel 150 is located. That is, FIG. 1 illustrates an example of detecting a user's mouth gesture using the camera 110 disposed in the front side of the terminal 100. Generally, since the user 1 tends to execute a specific application right after unlocking the terminal 100, it will be preferable to detect a user's mouth gesture using the camera 110 disposed in the front side of the terminal 100.

However, another camera other than the camera 110 disposed in the front side of the terminal 100 may be used to detect the user's face region (that is, a mouth region). Also, the user's mouth gesture may be used to unlock a device, such as a notebook with a camera, a wearable computer with a camera, and the like. For example, the user's mouth gesture may be used for a user authentication for a wearable watch, wearable glasses, etc., which are kinds of wearable computers.

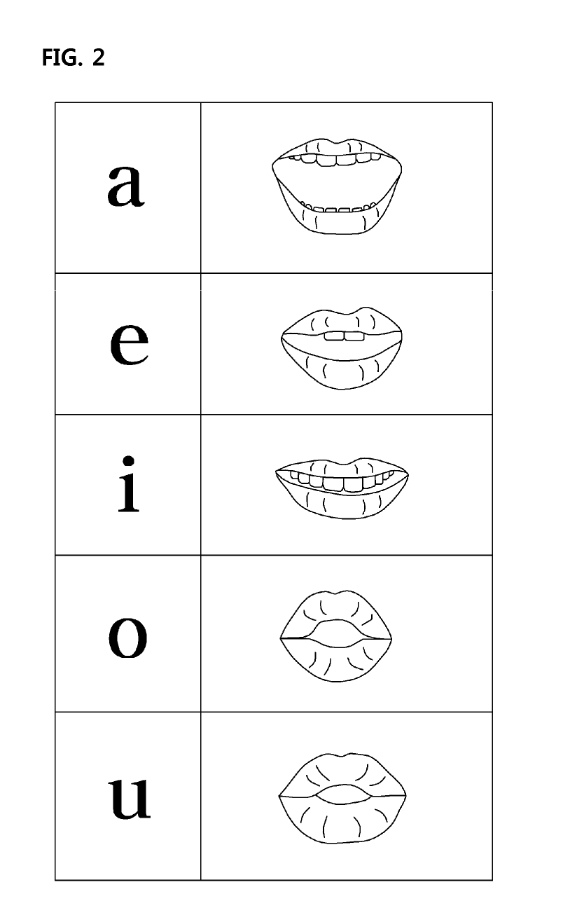

FIG. 2 illustrates examples of mouth gestures corresponding to vowels. Generally, when users speak specific pronunciation, the users tend to make the same or similar mouth shape although there are more or less differences according to the users' languages and linguistic habits. In this disclosure, a user's specific mouth gesture is used as an input for unlocking a terminal, regardless of the user's language.

In FIG. 2, mouth gestures for five vowels of a, e, i, o, and u are shown. However, a mouth gesture is not limited to a gesture of pronouncing a specific vowel. That is, a mouth gesture is at least one gesture among a gesture of pronouncing at least one vowel, a gesture of pronouncing at least one consonant, a gesture of pronouncing a specific syllable, a gesture of pronouncing a specific word, and a gesture of pronouncing a specific sentence.

In this disclosure, a terminal acquires an image of a user's mouth gesture using a camera, and processes the acquired image to detect the user's mouth gesture. The terminal compares the detected mouth gesture to a predetermined unlock gesture. The predetermined unlock gesture corresponds to a password for unlocking the terminal. The predetermined unlock gesture may be stored in advance in the terminal. The predetermined unlock gesture may also be at least one gesture among a gesture of pronouncing at least one vowel, a gesture of pronouncing at least one consonant, a gesture of pronouncing a specific syllable, a gesture of pronouncing a specific word, and a gesture of pronouncing a specific sentence.

Since the mouth gesture is a mouth shape excluding pronunciation, a command input method according to the present invention may be effectively used in a silent place such as a classroom or a meeting room.

The terminal uses an image processing technique to detect the user's mouth gesture from the image acquired by the camera. The image processing technique may be one of various image processing techniques well-known to one of ordinary skill in the art. Since the image processing technique is well-known to one of ordinary skill in the art, a description thereof will be briefly given below.

An image captured by the camera of the terminal generally includes a user's entire face.

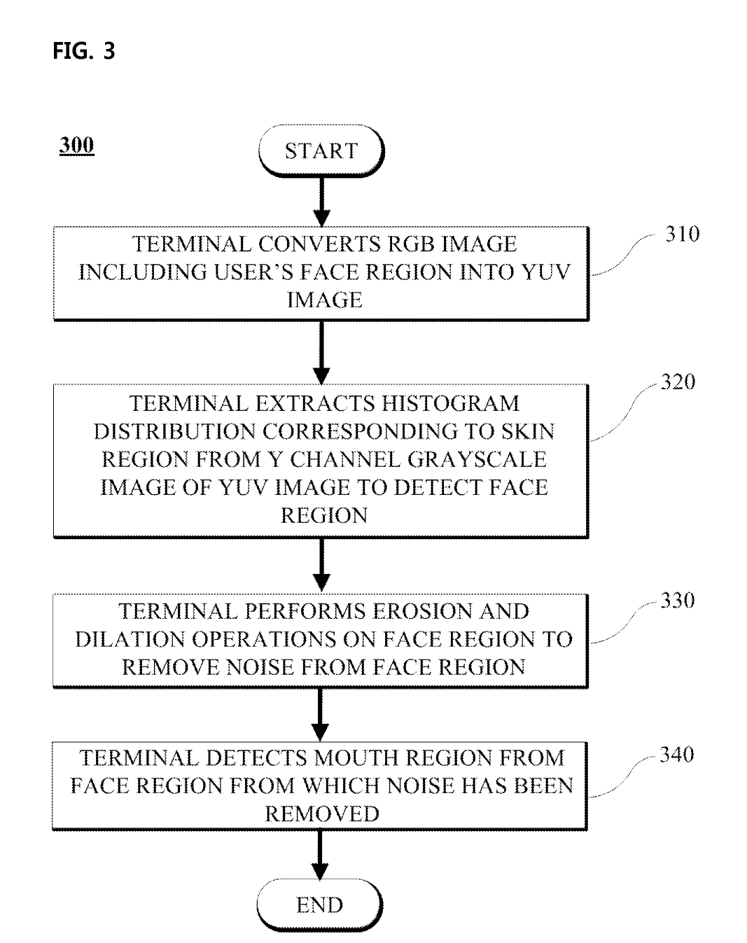

FIG. 3 is a flowchart illustrating an example of a process 300 of detecting a mouth gesture from an image including a user's face. Referring to FIG. 3, the process 300 of detecting the mouth gesture from the image including the user's face includes: at an image processor such as a main processor or a graphics processing unit (GPU) of a terminal, converting an RGB image including a user's face region into a YUV image (310); extracting a histogram distribution corresponding to a skin region from a Y channel grayscale image of the YUV image to detect a face region (320); performing erosion and dilation operations on the face region to remove noise from the face region (330); and detecting a mouth region from the face region from which the noise has been removed (340).

Operation 310 of converting the RGB image into the YUV image is a pre-processing for converting the RGB image into a grayscale image. By extracting only Y channels from the YUV image, a grayscale image can be represented. Operation 320 of detecting the face region is to detect a face region based on differences in a histogram distribution of the grayscale image. That is, since a human's face (skin) color has a different histogram distribution from that of a background, it is possible to extract only a face region from an image including the face region. Operation 330 of removing noise is to convert the face region into a binary image, and then perform erosion and dilation operations to remove the noise. Operation 340 of detecting the mouth region is to extract a mouth region using a threshold value for the binary image. That is, since a mouth (lips) region of a face region has a lower brightness distribution than the remaining region, it is possible to extract a mouth region from the face region using a specific threshold value. The threshold value is criteria well-known in the art.

However, a method of detecting a mouth gesture from an image including a user's face is not limited to operations 310 to 340 as described above.

Then, the terminal compares the detected mouth region to a pre-stored unlock gesture to detect a mouth gesture. The terminal may detect a mouth gesture from the mouth region, using at least one among an aspect ratio of lips, a size of lips, a size of an imaginary quadrangle surrounding lips, a size of an imaginary circle surrounding lips, and outlines of lips. However, the mouth gesture may be detected using other criterion for detecting a mouth region than the above-mentioned criterion.

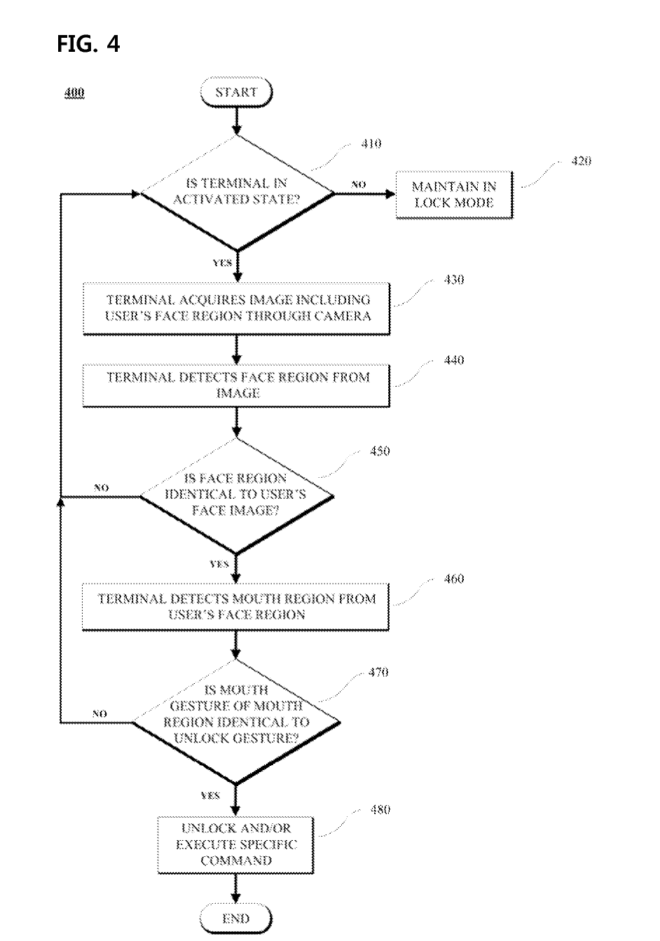

FIG. 4 is a flowchart illustrating an example of a command input method 400 of a terminal. The command input method 400 includes: at the terminal, acquiring an image including a user's face region through a camera (430); at the terminal, detecting a mouth region from the user's face region (460); and at the terminal, inputting a command to the terminal or to an application being executed in the terminal if a mouth gesture of the user's mouth region is identical to a pre-stored unlock gesture (480).

Before operation 430 of acquiring the image including the user's face region, the terminal determines whether the terminal is in an activated state or in an idle state (410). If the terminal is in the idle state, the terminal is maintained in a lock mode (420). If the terminal is in the activated state, the terminal acquires an image including a user's face region through the camera (430). The terminal may be activated when a user presses a button for turning on a display of the terminal, when the user touches a touch panel, or when a sensor installed in the terminal senses motion of the terminal.

In operation 480, the command is a command that is input to the terminal or to an application being executed in the terminal. The command may be an unlock command for releasing a lock mode of the terminal or the application. Furthermore, the command may be recognized as an independent command by the terminal or the application while unlocking the terminal or the application. For example, the command may be recognized as a command for executing a specific application, a command for terminating a specific application, a command for dialing a specific phone number, and a command for sending a message to a person with a specific phone number.

Also, before operation 460 of detecting the mouth region from the user's face region, an operation of performing an authentication using the user's face image may be additionally performed. That is, before operation 460 of detecting the mouth region from the user's face region, operation 440 of detecting the user's face region from the image and operation 450 of determining whether the user's face region is identical to an authorized user's face image stored in the terminal may be performed. The authorized user's face image is an image of an authorized user, stored in the terminal by the authorized user.

The mouth gesture may be detected by analyzing the mouth region. The mouth gesture is a mouth shape made when the user speaks specific pronunciation. As described above, the mouth gesture may be a mouth shape or a series of mouth shapes made when the user pronounces a specific word.

That is, the mouth gesture is at least one gesture among a gesture of pronouncing at least one vowel, a gesture of pronouncing at least one consonant, a gesture of pronouncing a specific syllable, a gesture of pronouncing a specific word, and a gesture of pronouncing a specific sentence.

The unlock gesture is a mouth image stored in the terminal by the user. In the present embodiment, since the command that is executed in operation 480 is an unlock command, the command is referred to as an unlock gesture. The unlock gesture is also at least one gesture among a gesture of pronouncing at least one vowel, a gesture of pronouncing at least one consonant, a gesture of pronouncing a specific syllable, a gesture of pronouncing a specific word, and a gesture of pronouncing a specific sentence. The unlock gesture is a mouth shape image acquired through the camera and then stored in the terminal by the user in order to perform an unlock command or a specific command.

Generally, when users speak specific pronunciation, the users tend to make the same or similar mouth shape. For example, as illustrated in FIG. 2, when users pronounce specific vowels, the same or similar mouth shapes are made. Accordingly, the terminal may use a standardized unlock gesture matching a specific vowel, a specific consonant, a specific syllable, a specific word, or a specific sentence. In this case, the terminal compares the user's mouth gesture to a standardized, specific unlock gesture stored in the terminal by a manufacturing company of the terminal or by an application provider. The standardized, specific unlock gesture is referred to as a standard gesture. The standard gesture is at least one gesture among a gesture of pronouncing a specific vowel, a gesture of pronouncing a specific consonant, a gesture of pronouncing a specific syllable, a gesture of pronouncing a specific word, and a gesture of pronouncing a specific sentence.

As described above, the user may execute a specific application while unlocking the terminal, by making the same mouth gesture as the unlock gesture. For example, if a mouth gesture is “Internet” or “In”, the terminal may execute a web browser while releasing a lock mode. As another example, if the mouth gesture is “Camera”, the terminal may execute a camera application.

Also, the terminal may control a predetermined function using the same mouth gesture as the unlock gesture. For example, the terminal may power off the terminal, remove a process being executed on the background of the terminal, control volume settings of the terminal, or switch a normal mode to a vibration mode, according to a mouth gesture.

The command may be stored in the terminal when the terminal or the application is produced, or may be set by a user.

There are various customized commands other than commands for executing specific applications and for controlling functions of the terminal, as described above. For example, if a mouth gesture corresponds to a specific person's name, the terminal may execute an application of making a call to the specific person or an application of sending a message to the specific person.

However, an operation of performing a specific command using a mouth gesture may be performed in various manners other than the examples described above.

The unlock operation may be applied to the terminal and to an application being executed in the terminal. In case of a terminal such as a smartphone, operating the terminal may also be interpreted as an execution of an application.

An example of executing a specific command while releasing a lock mode may be applied to a terminal. For example, when a camera function is executed, it is general to execute the camera function while releasing the lock mode of the terminal.

Also, the example of executing the specific command while releasing the lock mode may be applied to an application. For example, a command for dialing a specific phone number while unlocking a call application may be transferred. That is, a mouth gesture may be used as input data for executing an application.

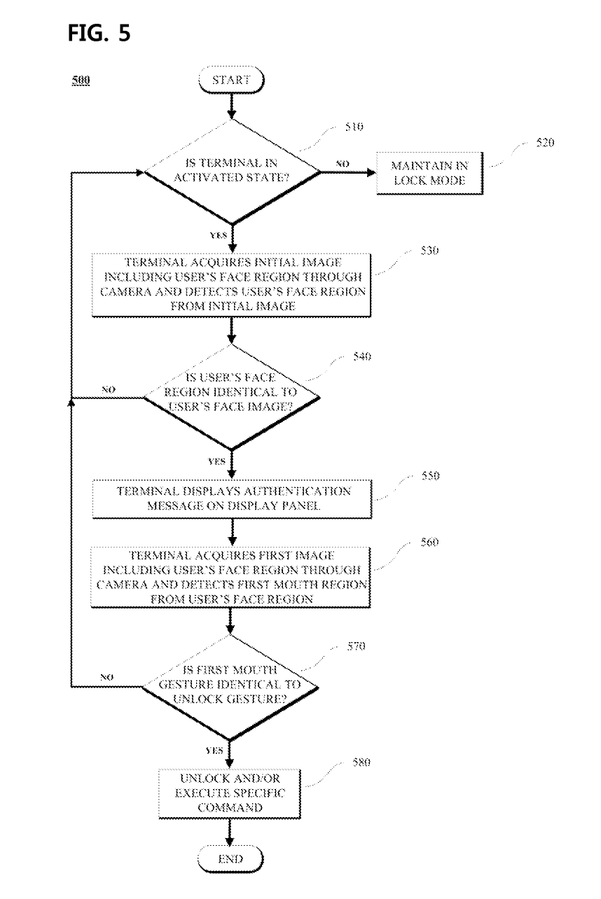

FIG. 5 is a flowchart illustrating an example of a command input method 500 of a terminal. The command input method 500 is different from the command input method 400 of FIG. 4 in that a mouth shape corresponding to an authentication message displayed on a display of the terminal is used.

The authentication message is at least one among at least one vowel, at least one consonant, a specific syllable, a specific word, and a specific sentence.

The command input method 500 of FIG. 5 includes: at the terminal, displaying an authentication message on a display panel (550); at the terminal, acquiring a first image including a user's face region through a camera and detecting a first mouth region from the user's face region (560); at the terminal, determining whether a first mouth gesture corresponding to the first mouth region is identical to an unlock gesture corresponding to the authentication message (570); and inputting a command to the terminal or to an application being executed in the terminal if the first mouth gesture is identical to the unlock gesture (580).

Before operation 550 of displaying the authentication message, the terminal may determine whether the terminal is in an activated state (510), and maintains a lock mode if the terminal is not in the activated state (520). If it is determined that the terminal is in the activated state, the terminal performs the following operation. After it is determined that the terminal is in the activated state, the terminal may display the authentication message on the display panel (550).

However, the command input method 500 may need a user authentication procedure. The reason is because if the terminal displays an authentication message, other persons may read the authentication message and make the same or similar mouth shape as the authentication message.

Accordingly, if it is determined that the terminal is in the activated state, the command input method 500 may include operation 530 of acquiring an initial image including a user's face region through a camera and detecting the user's face region from the initial image, and operation 540 of determining whether the user's face region is identical to an authorized user's face image stored in the terminal.

As illustrated in FIG. 5, when the face region included in the initial image is identical to the authorized user's face image, the terminal may display an authentication message on the display panel.

Alternatively, the terminal may acquire a first image, and determine whether a face region included in the first image is identical to an authorized user's face image. Thereafter, if the face region included in the first image is identical to the user's face image, the terminal may detect a first mouth region (560), or determine whether the first mouth region is identical to an unlock gesture (570).

In summary, as illustrated in FIG. 5, the terminal may perform an authentication using a face region of an initial image acquired before displaying an authentication message (540), or perform an authentication using a face region of a first image acquired after displaying the authentication message. The number of camera operations in the latter case is smaller than that in the former case.

The command input method 500 may unlock the terminal/application and/or execute a specific command using a first mouth gesture of the first mouth region, like the command input method 400 illustrated in FIG. 4 (580). In this case, the command is a command matching the authentication message or at least one syllable constituting the authentication message and stored in advance in the terminal. In order to execute a command reflecting a user's intention, a plurality of authentication messages are displayed to allow the user to select a message associated with a specific command from among the authentication messages. The command may be one of various commands, as described above with reference to FIG. 4.

Although not illustrated in FIG. 5, after operation 580 of unlocking the terminal/application, an operation of acquiring a second image through the camera and detecting a second mouth region from the second image (590), and an operation of executing a command corresponding to a mouth gesture of the second mouth region (595) may be further performed.

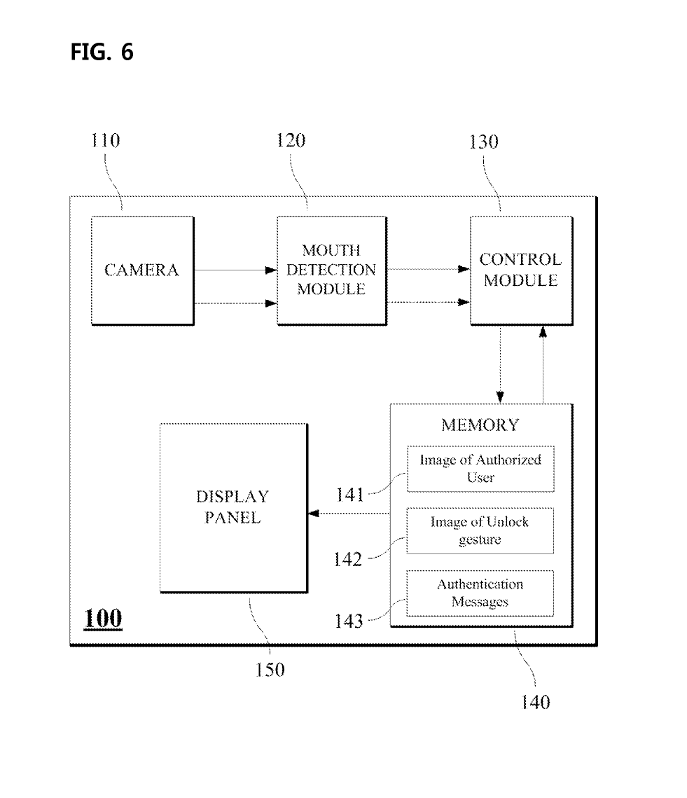

FIG. 6 is a block diagram illustrating an example of a configuration of a terminal 100 inputting a command using a mouth gesture. The terminal 100 includes a camera 110 for acquiring an image including a user's face region, a mouth detection module 120 for detecting a mouth region from the image using an image processing technique, a memory 140 storing an unlock gesture 142, and a control module 130 for comparing a mouth gesture of the mouth region to the unlock gesture to input a command to the terminal 100 or an application being executed in the terminal 100.

The terminal 100 may operate according to the command input method 400 illustrated in FIG. 4 or the command input method 500 illustrated in FIG. 5.

The memory 140 may further store an authorized user's face image 141. The control module 130 may detect the user's face region from the acquired image, and compare the mouth region to the unlock gesture if the user's face region is identical to the authorized user's face image 141.

The mouth detection module 120 may detect the user's face region using a histogram distribution of the image, and detect the mouth region from a grayscale image of the user's face region by thresholding brightness values.

The mouth detection module 120 may detect a mouth gesture from the mouth region, using at least one of an aspect ratio of lips, a size of lips, a size of an imaginary quadrangle surrounding lips, a size of an imaginary circle surrounding lips, and outlines of lips.

The unlock gesture is a user's mouth gesture acquired through the camera 110 and stored in the memory 140 by the user, or a standard gesture matching at least one of a specific vowel, a specific consonant, a specific syllable, a specific word, and a specific sentence.

The user may store his/her face image and an unlock gesture in the memory 140 using the camera 110 of the terminal 100. An arrow denoted by dotted lines in FIG. 5 corresponds to a path along which the user has stored the face image and the unlock gesture.

In order to perform the command input method 500 illustrated in FIG. 5, the memory 140 may further store authentication messages 143 and further include a display panel 150 for outputting the stored authentication messages 143.

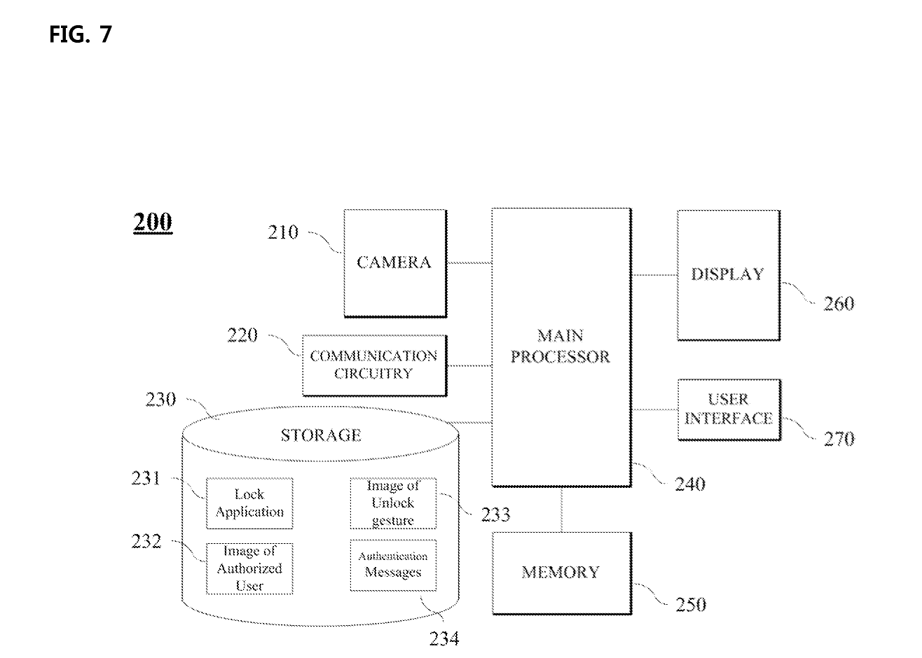

FIG. 7 is a block diagram illustrating an example of a configuration of a terminal 200 inputting a command using a mouth gesture. The terminal 200 includes a camera 210, a communication circuitry 220, a data storage unit 230, a main processor 240, a memory 250, a display unit 260, and a user interface 270.

The camera 210 includes various camera devices installed in the terminal 200. Preferably, the camera 210 is disposed in the front side of the terminal 200 on which a display panel is positioned. The communication circuitry 220 is a component for voice and data communication of the terminal 200.

The data storage unit 230 includes a random-access memory (RAM), a security digital (SD) card, a universal subscriber identity module (USIM) card, and the like, which are installed in the terminal 200. The memory 250 is a cache or a read-only memory (ROM) required for the main processor 240 to process various operations.

The display unit 260 includes various display panels used in the terminal 200 and circuits for display. The user interface 270 includes a keypad, a touch panel, and the like for allowing a user to input commands to the terminal 200.

In the terminal 200, components for performing the command input methods 400 and 500 illustrated in FIGS. 4 and 5 are the camera 210, the data storage unit 230, the main processor 240, and the display unit 260.

The terminal 200 acquires an image including a user's face region through the camera 210. Then, the main processor 240 detects the user's face region and a mouth region from the image, and determines whether a mouth gesture of the mouth region is identical to an unlock gesture. The main processor 240 of the terminal 200 corresponds to the mouth detection module 120 and the control module 130 of FIG. 6.

The data storage unit 230 stores a lock application 231, an authorized user's image 232, and an unlock gesture's image 233. Also, the data storage unit 230 may store authentication messages 234.

The lock application 231 is a list of applications that are locked based on a mouth gesture by a user among applications stored in the terminal 200. The main processor 240 checks the lock application 231 before a user executes a specific application, to determine whether to unlock the specific application using a mouth gesture.

The authorized user's image 232 is an authorized user's face image that is to be compared to a face region detected from an image acquired through the camera 210. The user may photograph faces of persons accessible to the terminal 100 in advance, and store the photographed faces as authorized user's images 232. The authorized user's image 232 is created by removing a background from an image photographed by the user to extract a face region. The unlock gesture's image 233 is an unlock gesture stored by the user or a standard gesture stored in the terminal 200. The authentication messages 234 are messages that are output on the display unit 260 in order to unlock the terminal 200 or a specific application.

Hereinafter, an operation of the terminal 200 will be briefly described. The terminal 200 uses a lock function based on a mouth gesture. If a user inputs a command for turning on the display unit 260, the main processor 240 determines that the terminal 200 uses the lock function based on the mouth gesture with reference to the lock application 231 stored in the data storage unit 230. Then, the terminal 200 acquires the user's image through the camera 210, performs an image processing on the user's image, and then detects a mouth gesture. Then, the terminal 200 causes the main processor 240 to compare the mouth gesture to the unlock gesture's image 233 stored in the data storage unit 230, and to unlock the terminal 200 if the mouth gesture is identical to the unlock gesture's image 233.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A command input method of a terminal with a camera, comprising:
acquiring an image including a user's face region through the camera;
detecting a mouth region from the user's face region;
inputting a command to the terminal or to an application being executed in the terminal if a mouth gesture of the mouth region is identical to an unlock gesture stored in the terminal.

2. The command input method of claim 1, after acquiring the image including the user's face region, further comprising:
detecting the user's face region from the image; and
determining whether the user's face region is identical to an authorized user's face image stored in the terminal,
wherein the detecting of the mouth region from the user's face region comprises detecting the mouth region if the user's face region is identical to the authorized user's face image.

3. The command input method of claim 1, wherein the mouth gesture is at least one gesture among a gesture of pronouncing at least one vowel, a gesture of pronouncing at least one consonant, a gesture of pronouncing a specific syllable, a gesture of pronouncing a specific word, and a gesture of pronouncing a specific sentence.

4. The command input method of claim 1, wherein the unlock gesture is the user's mouth gesture acquired through the camera and stored in the terminal by the user, or a standard gesture matching at least one of a specific vowel, a specific consonant, a specific syllable, a specific word, and a specific sentence.

5. The command input method of claim 1, wherein the command is an unlock command.

6. The command input method of claim 5, wherein the command further includes at least one command among a command for executing a specific application, a command for terminating a specific application, a command for dialing a specific phone number, and a command for sending a message to a person with a specific phone number.

7. A command input method of a terminal with a camera, comprising:
displaying an authentication message on a display panel of the terminal;
acquiring a first image including a user's face region through the camera;
detecting a first mouth region of the user from the user's face region; and
inputting a command to the terminal or to an application being executed in the terminal if a first mouth gesture of the first mouth region is identical to an unlock gesture corresponding to the authentication message.

8. The command input method of claim 7, before displaying the authentication message, further comprising:
detecting the user's face region from the first image acquired through the camera; and
determining whether the user's face region is identical to an authorized user's face image stored in the terminal,
wherein the displaying of the authentication message comprises displaying the authentication message only if the user's face region is identical to the authorized user's face image.

9. The command input method of claim 7, after acquiring the first image, further comprising, determining whether the user's face region is identical to the authorized user's face image stored in the terminal,
wherein the detecting of the first mouth region is performed only if the user's face region is identical to the authorized user's face image.

10. The command input method of claim 7, wherein the authentication message is at least one among at least one vowel, at least one consonant, a specific syllable, a specific word, and a specific sentence.

11. The command input method of claim 7, wherein the command is an unlock command.

12. The command input method of claim 7, wherein the command is a command matching the authentication message or at least one syllable constituting the authentication message and stored in advance in the terminal.

13. The command input method of claim 11, after inputting the command to the terminal or to the application, further comprising:
acquiring a second image through the camera, and detecting a second mouth region of the user from the second image; and
executing a command corresponding to a mouth gesture of the second mouth region.

14. The command input method of claim 11, wherein the command includes at least one command among a command for executing a specific application, a command for terminating a specific application, a command for dialing a specific phone number, and a command for sending a message to a person with a specific phone number.

15. A terminal of inputting a command using a mouth gesture, the terminal comprising:
a camera acquiring an image including a user's face region;
a mouth detection module detecting a mouth region from the image using an image processing technique;
a memory storing an unlock gesture; and
a control module comparing a mouth gesture of the mouth region to the unlock gesture, and inputting a command to the terminal or to an application being executed in the terminal.

16. The terminal of claim 15, wherein the memory further stores an authorized user's face image, and
the control module detects the user's face region from the image, and compares the mouth region to the unlock gesture if the user's face region is identical to the authorized user's face image.

17. The terminal of claim 15, wherein the mouth detection module detects the user's face region using a histogram distribution of the image, and detects the mouth region from a grayscale image about the user's face region by thresholding brightness values.

18. The terminal of claim 15, wherein the mouth detection module recognizes the mouth gesture from the mouth region, using at least one among an aspect ratio of lips, a size of the lips, a size of an imaginary quadrangle surrounding the lips, a size of an imaginary circle surrounding the lips, and outlines of the lips.

19. The terminal of claim 15, wherein the unlock gesture is a user's mouth gesture acquired through the camera and stored in the terminal by the user, or
a standard gesture matching at least one of a specific vowel, a specific consonant, a specific syllable, a specific word, and a specific sentence.

20. The terminal of claim 15, further comprising a display panel outputting an authentication message stored in the memory, wherein the unlock gesture is a mouth gesture corresponding to the authentication message.
